(19) United States
(12) Patent Application Publication
(10) Pub. No.: US 2015/0024685 A1
(43) Pub. Date: Jan. 22, 2015

(54) POWER TRANSMISSION SYSTEM AND POWER TRANSMITTER DEVICE

(71) Applicant: Murata Manufacturing Co., Ltd., Nagaokakyo-shi (JP)

(72) Inventors: Shinji Goma, Nagaokakyo-shi (JP); Tsutomu leki, Nagaokakyo-shi (JP)

(21) Appl. No.: 14/505,142

(22) Filed: Oct. 2, 2014

Related U.S. Application Data
(63) Continuation of application No. PCT/JP2013/058077, filed on Mar. 21, 2013.

(30) Foreign Application Priority Data
Jun. 15, 2012 (JP) 2012-135549

(51) Int. Cl. H04B 5/00; H02J 17/00; H02J 5/00

(52) U.S. Cl. CPC H04B 5/0012; H02J 5/00; H04B 5/0037; H02J 17/00
USPC 455/41.1; 307/149

(57) ABSTRACT

A power transmission system and power transmitter device that suppress degradation of communication quality in data communication even when the data communication and power transmission are performed concurrently.

One end portion of a first communication unit of a power transmitter device is connected to a first communication coupling electrode, and one end portion of a second communication unit of a power receiver device is connected to a second communication coupling electrode that forms capacitive coupling with the first communication coupling electrode. The other end portion of the first communication unit is connected to a reference potential electrode of the power transmitter device, and the other end portion of the second communication unit is connected to a reference potential electrode of the power receiver device.

### CROSS REFERENCE TO RELATED APPLICATIONS

The present application is a continuation of PCT/JP2013/058077 filed Mar. 21, 2013, which claims priority to Japanese Patent Application No. 2012-135549, filed Jun. 15, 2012, the entire contents of each of which are incorporated herein by reference

### FIELD OF THE INVENTION

The present invention relates to power transmission systems and power transmitter devices that transmit electric power without connecting physically. In particular, the present invention relates to a power transmission system and a power transmitter device that may be used for both electric-field coupling type power transmission and data communication.

### BACKGROUND OF THE INVENTION

In recent years, various electronic devices that transmit power contactlessly have been developed. Contactless data communications in electronic devices may be performed easily by wireless LAN or the like. Further, in consideration of security in data communication, an electronic device that allows data communication only when it is placed at a predetermined location is also being developed.

For example, in a power supply (transmission) system disclosed in patent document 1, a power source is provided at a fixed body (power transmitter device), and a load circuit is provided at a mobile body (power receiver device). Further, communication units are respectively disposed in parallel with the power source and the load circuit. FIG. 13 is a schematic circuit diagram illustrating an arrangement of communication units in a conventional power transmission system.

In FIG. 13, a power transmitter device 1 is coupled to a power receiver device 2 by electric-field coupling through a first coupling electrode pair A and a second coupling electrode pair P. An end portion of a first communication unit 13 of the power transmitter device 1 is connected to an end portion of a voltage generator circuit (power source) 12. The other end portion of the first communication unit 13 is connected to a power line that extends up to the first coupling electrode pair A via a coupler. An end portion of a second communication unit 23 of the power receiver device 2 is connected to an end portion of a load circuit 24. The other end portion of the second communication unit 23 of the power receiver device 2 is connected to a power line that extends up to the first coupling electrode pair A via a coupler.

The power receiver device 2 receives an alternate current power from the power transmitter device 1 via the first and second coupling electrode pairs A and P, converts to a direct current power with a rectifier circuit 22, and supplies to the load circuit 24. In the power receiver device 2, an end portion of the load circuit 24 is grounded so as to be at a reference potential. For example, the end portion of the load circuit 24 may be connected to a ground electrode (ground pattern) of a circuit board or a shield portion (shield case) of a casing of the power receiver device 2 or the like. The first communication unit 13 and the second communication unit 23 are allowed to communicate to each other when the first coupling electrode pair A is coupled to the second coupling electrode pair P by electric-field coupling. This enables to perform power transmission while performing data communication at the same time.

Patent Document 1: Japanese Unexamined Patent Application Publication No. 2009-089520

However, as illustrated in FIG. 13, when the first communication unit 13 and the second communication unit 23 are disposed in parallel with the voltage generator circuit (power source) 12 of the power transmitter device 1 and the load circuit 24 of the power receiver device 2, the first communication unit 13 and the second communication unit 23 modulate directly with a power signal that is at high voltage. Accordingly, the level of signal to be inputted to the first communication unit 13 and the second communication unit 23 may vary greatly when the power varies for some reasons. Thus, there are problems that noise is easily mixed in and high communication quality and stable data communication are difficult to maintain.

### SUMMARY OF THE INVENTION

The present invention is made in view of the foregoing circumstances, and an object thereof is to provide a power transmission system and a power transmitter device that enable to suppress degradation of communication quality in data communication even when data communication and power transmission are performed at the same time.

To achieve the foregoing object, a power transmission system according to the present invention includes: a power transmitter device including at least a pair of first coupling electrodes, a first communication unit that enables data communication, and a first communication coupling electrode; and a power receiver device including at least a pair of second coupling electrodes, a second communication unit that enables data communication, and a second communication coupling electrode. Further, electric power is transmitted by forming capacitive coupling between the first coupling electrode and the second coupling electrode; one end portion of the first communication unit is connected to the first communication coupling electrode, and one end portion of the second communication unit is connected to the second communication coupling electrode that forms capacitive coupling with the first communication coupling electrode; another end portion of the first communication unit is connected to a first reference potential electrode of the power transmitter device, and another end portion of the second communication unit is connected to a second reference potential electrode of the power receiver device; and the first reference potential electrode is arranged between the first communication coupling electrode and the first coupling electrode, and the second reference potential electrode is arranged between the second communication coupling electrode and the second coupling electrode.

According to the foregoing configuration, the first reference potential electrode and the second reference potential electrode that are each connected to a reference potential are arranged between the first communication coupling electrode and the first coupling electrode of the power transmitter device and between the second communication coupling electrode and the second coupling electrode of the power receiver device, respectively. This enables to make the first communication coupling electrode less susceptible to the influence of a relatively high voltage applied to the first coupling electrode during power transmission and suppress potential variations at the first communication unit, making it possible to increase the SN ratio (signal to noise ratio) of communication signal. Thus, the communication sensitivity may be increased, and the data communication stability may be further improved.

Next, to achieve the foregoing object, a power transmission system according to the present invention includes: a power transmitter device including first coupling electrodes formed of a first passive electrode and a first active electrode that is at a higher potential than the first passive electrode, a first communication unit that enables data communication, and a first communication coupling electrode; and a power receiver device including second coupling electrodes formed of a second passive electrode and a second active electrode that is at a higher potential than the second passive electrode, a second communication unit that enables data communication, and a second communication coupling electrode. Further, electric power is transmitted by forming capacitive coupling between the first coupling electrode and the second coupling electrode; one end portion of the first communication unit is connected to the first communication coupling electrode, and one end portion of the second communication unit is connected to the second communication coupling electrode that forms capacitive coupling with the first communication coupling electrode; another end portion of the first communication unit is connected to a reference potential of the power transmitter device, and another end portion of the second communication unit is connected to a reference potential of the power receiver device; and the first passive electrode is arranged between the first active electrode and the first communication coupling electrode, and the second passive electrode is arranged between the second active electrode and the second communication coupling electrode.

According to the foregoing configuration, of the first coupling electrodes of the power transmitter device, the first passive electrode is arranged between the first active electrode and the first communication coupling electrode. Further, of the second coupling electrodes of the power receiver device, the second passive electrode is arranged between the second active electrode and the second communication coupling electrode. This enables to make the first communication coupling electrode less susceptible to the influence of a relatively high voltage applied to the first active electrode (first coupling electrode) during power transmission and suppress potential variations at the first communication unit, making it possible to increase the SN ratio (signal to noise ratio) of communication signal. Thus, the communication sensitivity may be increased, and the data communication stability may be further improved.

Further, in the power transmission system according to the present invention, it is preferable that the power transmitter device may include a first reference potential electrode disposed between the first passive electrode and the first communication coupling electrode, and that the power receiver device may include a second reference potential electrode disposed between the second passive electrode and the second communication coupling electrode.

According to the foregoing configuration, the first reference potential electrode is disposed between the first passive electrode and the first communication coupling electrode, and the second reference potential electrode is disposed between the second passive electrode and the second communication coupling electrode. This enables to make the first communication coupling electrode less susceptible to the influence of a relatively high voltage applied to the first active electrode (first coupling electrode) during power transmission and suppress potential variations at the first communication unit, making it possible to increase the SN ratio (signal to noise ratio) of communication signal. Thus, the communication sensitivity may be increased, and the data communication stability may be further improved.

Further, preferably, in the power transmission system according to the present invention, the first reference potential electrode of the power transmitter device may be connected to a ground potential.

According to the foregoing configuration, the reference potential is the ground potential. Thus, the reference potential stays constant and becomes less susceptible to the influence of potential variation during power transmission, making it possible to perform more stable data communication and power transmission at the same time.

Next, to achieve the foregoing object, a power transmitter device according to the present invention for transmitting electric power to a power receiver device includes at least a pair of first coupling electrodes, a first communication unit enabling data communication, and a first communication coupling electrode. One end portion of the first communication unit is connected to the first communication coupling electrode. Another end portion of the first communication unit is connected to a first reference potential electrode. The first reference potential electrode is arranged between the first communication coupling electrode and the first coupling electrode. The power receiver device includes at least a pair of second coupling electrodes, a second communication unit enabling data communication, and a second communication coupling electrode.

According to the foregoing configuration, the first reference potential electrode connected to a reference potential is arranged between the first communication coupling electrode and the first coupling electrode. This enables to make the first communication coupling electrode less susceptible to the influence of a relatively high voltage applied to the first coupling electrode during power transmission and suppress potential variations at the first communication unit, making it possible to increase the SN ratio (signal to noise ratio) of communication signal. Thus, the communication sensitivity may be increased, and the data communication stability may be further improved.

Next, to achieve the foregoing object, a power transmitter device according to the present invention for transmitting electric power to a power receiver device includes first coupling electrodes formed of a first passive electrode and a first active electrode being at a higher potential than the first passive electrode, a first communication unit enabling data communication, and a first communication coupling electrode. One end portion of the first communication unit is connected to the first communication coupling electrode. Another end portion of the first communication unit is connected to a reference potential. The first passive electrode is arranged between the first active electrode and the first communication coupling electrode. The power receiver device includes second coupling electrodes formed of a second passive electrode and a second active electrode being at a higher potential than the second passive electrode, a second communication unit enabling data communication, and a second communication coupling electrode.

According to the foregoing configuration, of the first coupling electrodes, the first passive electrode is arranged between the first active electrode and the first communication coupling electrode. This enables to make the first communication coupling electrode less susceptible to the influence of a relatively high voltage applied to the first active electrode (first coupling electrode) during power transmission and suppress potential variations at the first communication unit, making it possible to increase the SN ratio (signal to noise ratio) of communication signal. Thus, the communication sensitivity may be increased, and the data communication stability may be further improved.

Preferably, the power transmitter device according to the present invention may include a first reference potential electrode disposed between the first passive electrode and the first communication coupling electrode.

According to the forgoing configuration, the first reference potential electrode is disposed between the first passive electrode and the first communication coupling electrode. This enables to make the first communication coupling electrode less susceptible to the influence of a relatively high voltage applied to the first active electrode (first coupling electrode) during power transmission and suppress potential variations at the first communication unit, making it possible to increase the SN ratio (signal to noise ratio) of communication signal. Thus, the communication sensitivity may be increased, and the data communication stability may be further improved.

Preferably, in the power transmitter device according to the present invention, the first reference potential electrode may be connected to a ground potential.

According to the foregoing configuration, the reference potential is the ground potential. Thus, the reference potential stays constant and becomes less susceptible to the influence of potential variation during power transmission, making it possible to perform more stable data communication and power transmission at the same time.

The power transmission system and the power transmitter device according to the present invention enable to make the first communication coupling electrode less susceptible to the influence of a relatively high voltage applied to the first coupling electrode during power transmission and suppress potential variations at the first communication unit, making it possible to increase the SN ratio (signal to noise ratio) of communication signal. Thus, the communication sensitivity may be increased, and the data communication stability may be further improved.

### BRIEF DESCRIPTION OF DRAWINGS

FIG. 1 is a schematic block diagram of a configuration of a power transmission system according to embodiment 1 of the present invention.

FIG. 2 is a schematic block diagram of another configuration of the power transmission system according to the embodiment 1 of the present invention.

FIG. 3 is a schematic plan view of an arrangement of coupling electrode pairs in the power transmission system according to the embodiment 1 of the present invention.

FIG. 4 is a schematic block diagram of a configuration of a power transmission system according to embodiment 2 of the present invention.

FIG. 5 is a schematic block diagram of another configuration of the power transmission system according to the embodiment 2 of the present invention.

FIG. 6 is a schematic plan view of an arrangement of coupling electrode pairs in the power transmission system according to the embodiment 2 of the present invention.

FIG. 7 is a schematic block diagram of another configuration of the power transmission system according to the embodiment 2 of the present invention.

FIG. 8 is a schematic plan view of another arrangement of coupling electrode pairs of the power transmission system according to the embodiment 2 of the present invention.

FIG. 9 is a schematic block diagram of a configuration of a power transmission system according to embodiment 3 of the present invention.

FIG. 10 is a schematic plan view of an arrangement of coupling electrode pairs in the power transmission system according to the embodiment 3 of the present invention.

FIG. 11 is a schematic diagram of a smartphone that constitutes a power receiver device of a power transmission system according to embodiment 4 of the present invention.

FIG. 12 is a schematic longitudinal cross sectional diagram illustrating a configuration of a power transmitter device and a power receiver device of a power transmission system according to the embodiment 4 of the present invention.

FIG. 13 is a schematic circuit diagram illustrating an arrangement of communication units in a conventional power transmission system.

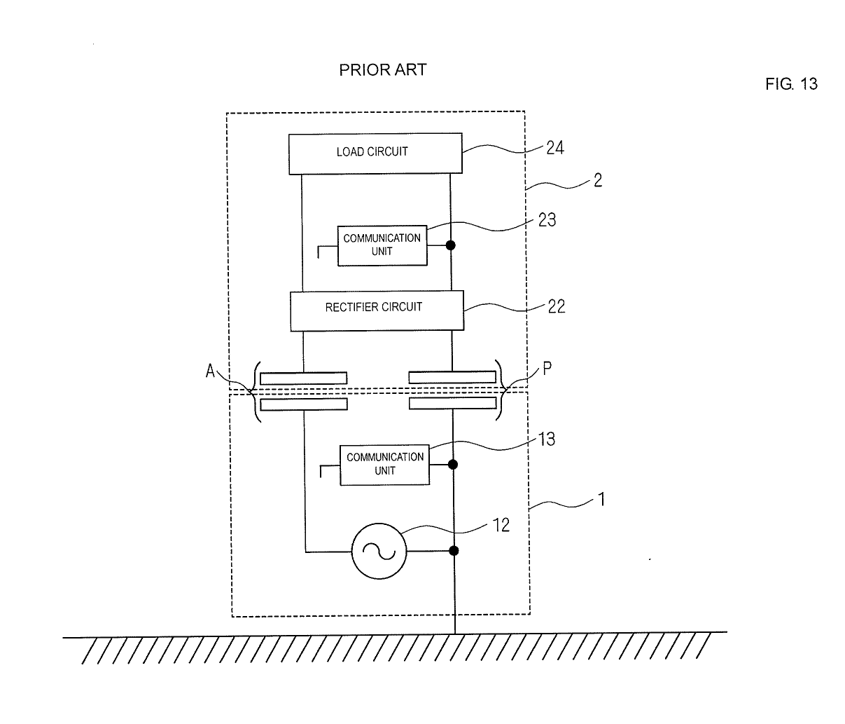

### DETAILED DESCRIPTION OF THE PREFERRED EMBODIMENTS

Power transmission systems according to embodiments of the present invention and power transmitter devices for use in the power transmission systems are described specifically with reference to the drawings. Needless to say, the following embodiments do not limit the invention described in the claims, and all of combinations of characteristic matters described in the following embodiments are not necessarily essential matters of the resolving means.

### Embodiment 1

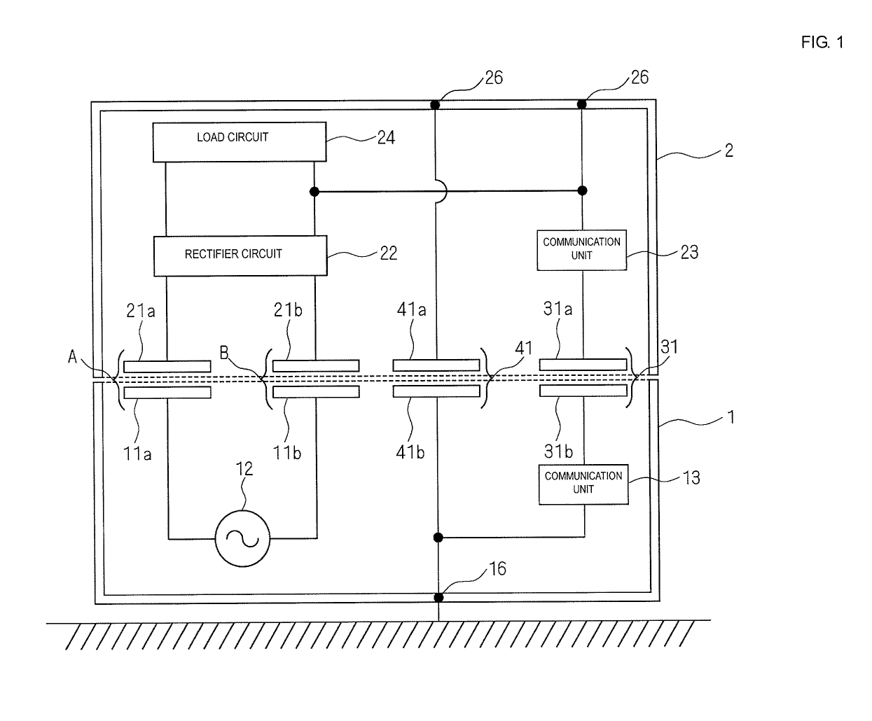

FIG. 1 is a schematic block diagram of a configuration of a power transmission system according to embodiment 1 of the present invention. As illustrated in FIG. 1, a power transmitter device 1 of the power transmission system according to the embodiment 1 includes at least a voltage generator circuit 12, a power transmitter module unit including a step-up transformer that is not illustrated, a pair of first coupling electrodes 11a and 11b, and a first communication coupling electrode 31b that forms a communication coupling electrode pair 31. Further, a power receiver device 2 includes at least a power receiver module unit including a step-down transformer that is not illustrated, a rectifier circuit 22, and a load circuit 24, a pair of second coupling electrodes 21a and 21b, and a second communication coupling electrode 31a that forms the communication coupling electrode pair 31. Here, the first coupling electrode 11a and the second coupling electrode 21a form a first coupling electrode pair A, and the first coupling electrode 11b and the second coupling electrode 21b form a second coupling electrode pair B.

The voltage generator circuit 12 of the power transmitter module unit of the power transmitter device 1 generates an alternate current voltage at a frequency of 10 kHz to 10 MHz, and the alternate current voltage generated is stepped up to 100 V to 10 kV with the step-up transformer. The alternate current voltage thus stepped up is transmitted contactlessly by forming capacitive coupling through the first coupling electrode pair A and the second coupling electrode pair B. The alternate current voltage transmitted is stepped down with the step-down transformer of the power receiver module unit of the power receiver device 2, and converted to a direct current voltage with the rectifier circuit 22. The direct current voltage is supplied to the load circuit 24.

The embodiment 1 is provided with, in addition to the first coupling electrode pair A and the second coupling electrode pair B for use in power transmission and the communication coupling electrode pair 31, a reference potential coupling electrode pair 41 formed of a first reference potential electrode 41b and a second reference potential electrode 41a is provided. Capacitive coupling through the reference potential coupling electrode pair 41 enables to stabilize the reference potential at the power receiver device 2 side.

Further, the reference potential coupling electrode pair 41 connected to the reference potential is arranged between the communication coupling electrode pair 31 and the electrode pairs, the first coupling electrode pair A and the second coupling electrode pair B. In the reference potential coupling electrode pair 41, the first reference potential electrode 41b at the power transmitter device 1 side is connected to a first reference potential electrode 16 (casing may also be used) of the power transmitter device 1, and the second reference potential electrode 41a at the power receiver device 2 side is connected to a second reference potential electrode 26 (casing may also be used) of the power receiver device 2.

A first communication unit 13 of the power transmitter device 1 is connected to the first communication coupling electrode 31b at one end portion and the first reference potential electrode 16 of the power transmitter device 1 at the other end portion. Further, a second communication unit 23 of the power receiver device 2 is connected to the second communication coupling electrode 31a, which forms capacitive coupling with the first communication coupling electrode 31b, at one end portion and the second reference potential electrode 26 of the power receiver device 2 at the other end portion.

Further, the first reference potential electrode 41b connected to the first reference potential electrode 16 is arranged between the first communication coupling electrode 31b and the pair of the first coupling electrodes 11a and 11b. The second reference potential electrode 41a connected to the second reference potential electrode 26 is arranged between the second communication coupling electrode 31a and the pair of the second coupling electrodes 21a and 21b.

The reference potential coupling electrode pair 41 that is respectively connected to the first reference potential electrode 16 and the second reference potential electrode 26 is arranged between the communication coupling electrode pair 31 and the first coupling electrode pair A and the second coupling electrode pair B. Thus, potential variations at the first coupling electrode pair A and the second coupling electrode pair B during power transmission may hardly influence the communication coupling electrode pair 31. Accordingly, unwanted voltages applied to the first communication unit 13 and the second communication unit 23 during power transmission may be greatly reduced, and the SN ratio (signal to noise ratio) of communication signal may be increased. Accordingly, the communication sensitivity may be increased, and the data communication stability may be further improved.

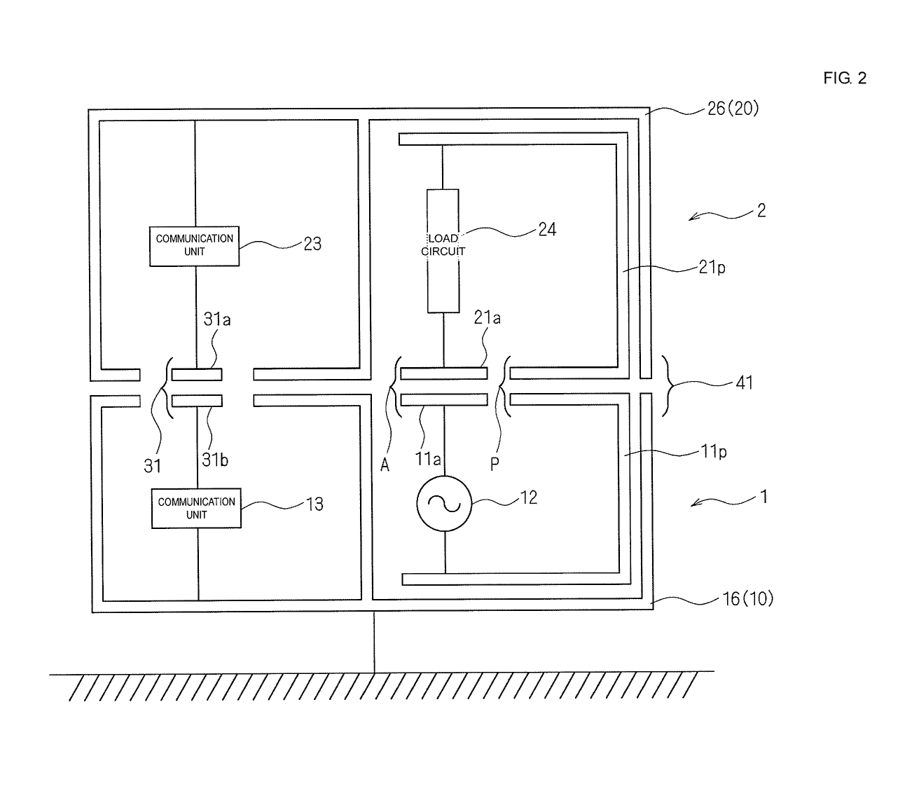

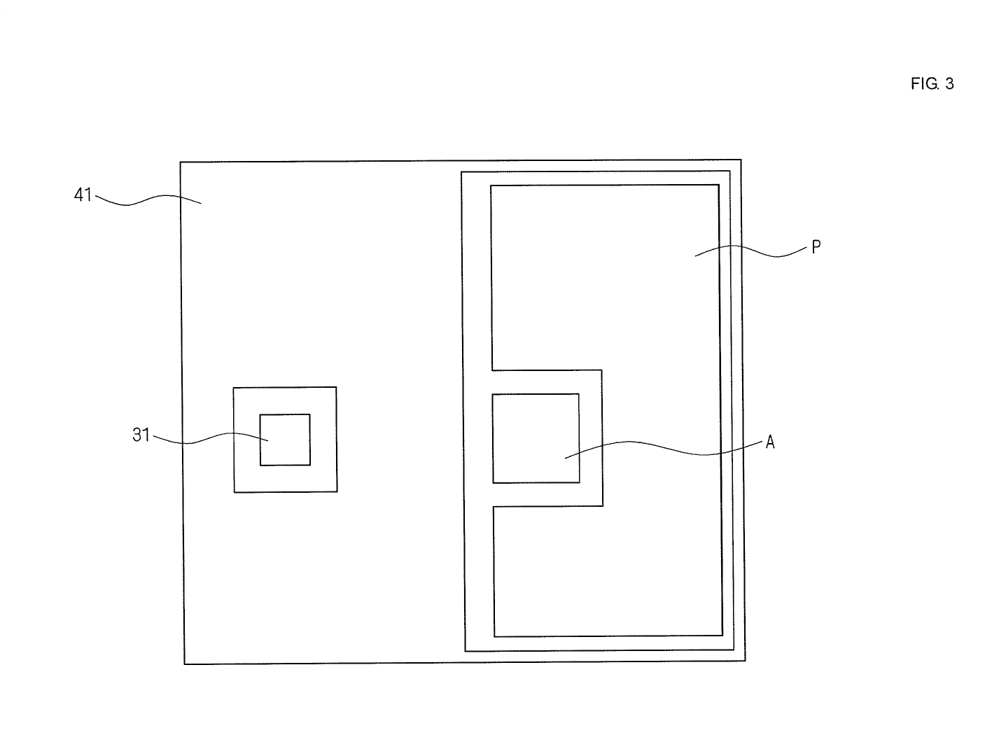

Alternatively, a casing of the power transmitter device 1 and a casing of power receiver device 2 may be configured so as to function as a reference potential coupling electrode pair 41. FIG. 2 is a schematic block diagram of another configuration of the power transmission system according to the embodiment 1 of the present invention. FIG. 3 is a schematic plan view of an arrangement of coupling electrode pairs in the power transmission system according to the embodiment 1 of the present invention.

As illustrated in FIG. 2, the power transmission system according to the embodiment 1 allows a casing 10 of a power transmitter device 1 and a casing 20 of a power receiver device 2 to function as a first reference potential electrode 16 and a second reference potential electrode 26 that are each connected to a reference potential. The power transmitter device 1 includes at least a voltage generator circuit 12, a power transmitter module unit including a step-up transformer that is not illustrated, and a pair of first coupling electrodes 11a and 11p. Further, the power receiver device 2 includes at least a power receiver module unit including a step-down transformer that is not illustrated and a load circuit 24, and a pair of second coupling electrodes 21a and 21p. In FIG. 1, the pair of the first coupling electrodes 11a and 11b has substantially the same electrode area, whereas in FIG. 2, the first coupling electrode 11a that is one of the first coupling electrodes has a smaller electrode area than the other first coupling electrode 11p. By connecting the voltage generator circuit 12 between the first coupling electrode 11a and the first coupling electrode 11p, a higher voltage is applied to the first coupling electrode 11a having the smaller electrode area compared to a voltage applied to the first coupling electrode 11p having the larger electrode area. Note that the first coupling electrode 11a and the second coupling electrode 21a form a first coupling electrode pair A, and that the first coupling electrode 11p and the second coupling electrode 21p form a second coupling electrode pair P.

Further, in addition to the first coupling electrode pair A and the second coupling electrode pair P for use in power transmission, a communication coupling electrode pair 31 that is connected to the reference potential is provided.

The casing 10 of the power transmitter device 1 and the casing 20 of the power receiver device 2 function as a reference potential coupling electrode pair 41 connected to the reference potential. A first communication unit 13 of the power transmitter device 1 is connected to a first communication coupling electrode 31b at one end portion and the casing 10 of the power transmitter device 1 at the other end portion. Further, a second communication unit 23 of the power receiver device 2 is connected to a second communication coupling electrode 31a, which forms capacitive coupling with the first communication coupling electrode 31b, at one end portion and the casing 20 of the power receiver device 2 at the other end portion.

The foregoing configuration allows to arrange the reference potential coupling electrode pair 41 formed of the casing 10 of the power transmitter device 1 and the casing 20 of the power receiver device 2 between the first coupling electrode pair A that is at a relatively high potential and the communication coupling electrode pair 31 that is susceptible to the influence of potential variation.

For example, in FIG. 3, the communication coupling electrode pair 31 is surrounded by the reference potential coupling electrode pair 41. Thus, the communication coupling electrode pair 31 is less influenced by the potential variations at the first coupling electrode pair A and the second coupling electrode pair P. In other words, the influence of potential variation superposed on the first communication unit 13 and the second communication unit 23 during power transmission may be reduced, and the SN ratio (signal to noise ratio) of communication signal may be increased. Accordingly, the communication sensitivity may be increased, and the data communication stability may be further improved.

As described above, according to the embodiment 1, the reference potential coupling electrode pair 41 connected to the reference potential is arranged between the communication coupling electrode pair 31 and the first coupling electrode pair A. This enables to make the communication coupling electrode pair 31 less susceptible to the influence of a relatively high voltage applied to the first coupling electrode pair A during power transmission and suppress potential variations at the first communication unit 13, making it possible to increase the SN ratio (signal to noise ratio) of communication signal. Thus, the communication sensitivity may be increased, and the data communication stability may be further improved.

### Embodiment 2

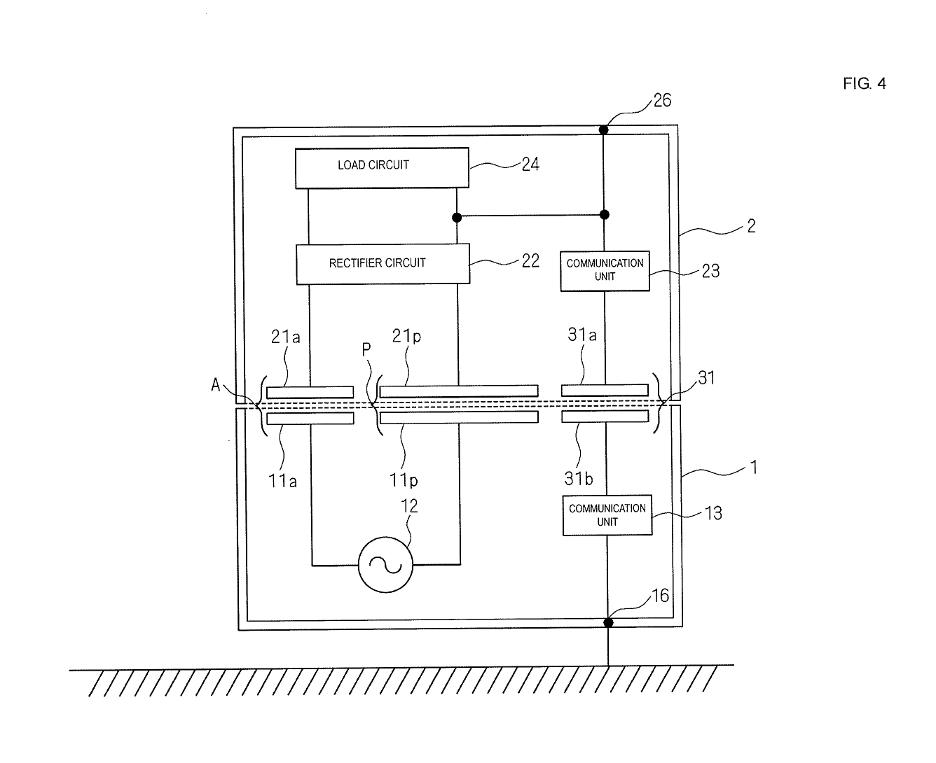

FIG. 4 is a schematic block diagram of a configuration of a power transmission system according to embodiment 2 of the present invention. As illustrated in FIG. 4, a power transmitter device 1 of the power transmission system according to the embodiment 2 includes at least a voltage generator circuit 12, a power transmitter module unit including a step-up transformer that is not illustrated, a first active electrode (first coupling electrode) 11a that forms a first coupling electrode pair A and a first passive electrode (first coupling electrode) 11p that forms a second coupling electrode pair P, and a first communication coupling electrode 31b that forms a communication coupling electrode pair 31. Further, a power receiver device 2 includes at least a power receiver module unit including a step-down transformer that is not illustrated, a rectifier circuit 22, and a load circuit 24, a second active electrode (second coupling electrode) 21a that forms the first coupling electrode pair A and a second passive electrode (second coupling electrode) 21p that forms the second coupling electrode pair P, and a second communication coupling electrode 31a that forms the communication coupling electrode pair 31.

The voltage generator circuit 12 of the power transmitter module unit of the power transmitter device 1 generates an alternate current voltage at a frequency of 10 kHz to 10 MHz, and the alternate current voltage thus generated is stepped up to 100 V to 10 kV with the step-up transformer. The alternate current voltage thus stepped up is transmitted contactlessly by forming capacitive coupling through the first coupling electrode pair A and the second coupling electrode pair P. The alternate current voltage transmitted is stepped down with the step-down transformer of the power receiver module unit of the power receiver device 2, and converted to a direct current voltage with the rectifier circuit 22. The direct current voltage is supplied to the load circuit 24.

In the embodiment 2, the first coupling electrode pair A and the second coupling electrode pair P are provided as the coupling electrode pairs for use in power transmission, in addition to the communication coupling electrode pair 31 for use in data communication. The first coupling electrode pair A is formed of the first active electrode 11a and the second active electrode 21a. The second coupling electrode pair P is formed of the first passive electrode 11p that is at a lower potential than the first active electrode 11a and the second passive electrode 21p that is at a lower potential than the second active electrode 21a.

A first communication unit 13 of the power transmitter device 1 is connected to the first communication coupling electrode 31b at one end portion and a first reference potential electrode 16 of the power transmitter device 1 at the other end portion. Further, a second communication unit 23 of the power receiver device 2 is connected to the second communication coupling electrode 31a, which forms capacitive coupling with the first communication coupling electrode 31b, at one end portion and a second reference potential electrode 26 of the power receiver device 2 at the other end portion.

Further, the second coupling electrode pair P that is at a relatively low potential is arranged between the first coupling electrode pair A that is at a relatively high potential and the communication coupling electrode pair 31 that is susceptible to the influence of potential variation. This enables to suppress leaking of an electric field generated by the first coupling electrode pair A for power transmission toward the communication coupling electrode pair 31 side, increase the communication sensitivity, and further improve the data communication stability.

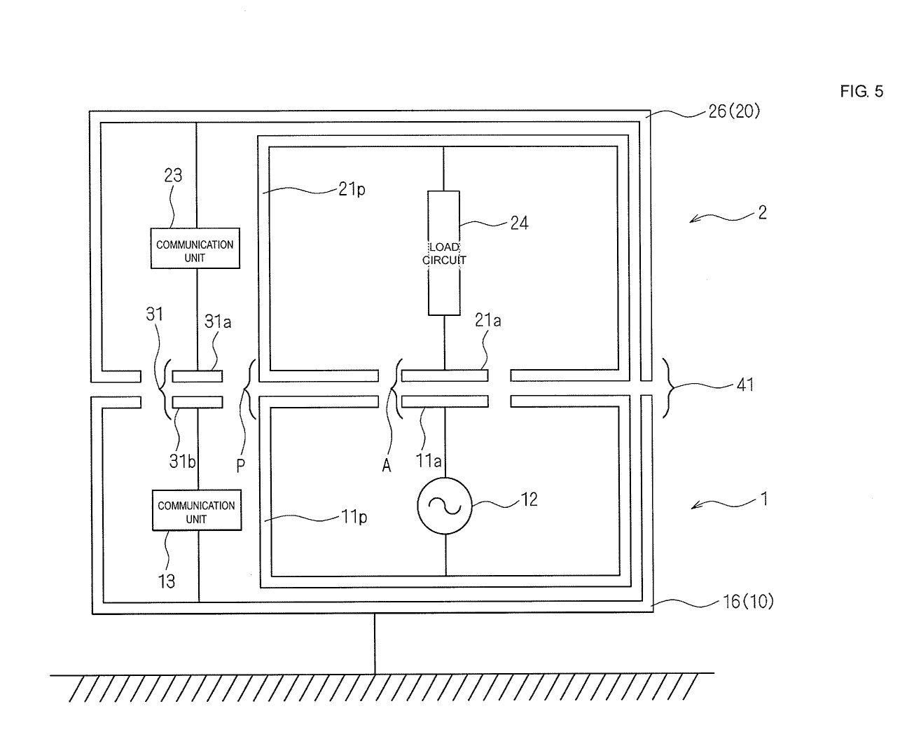

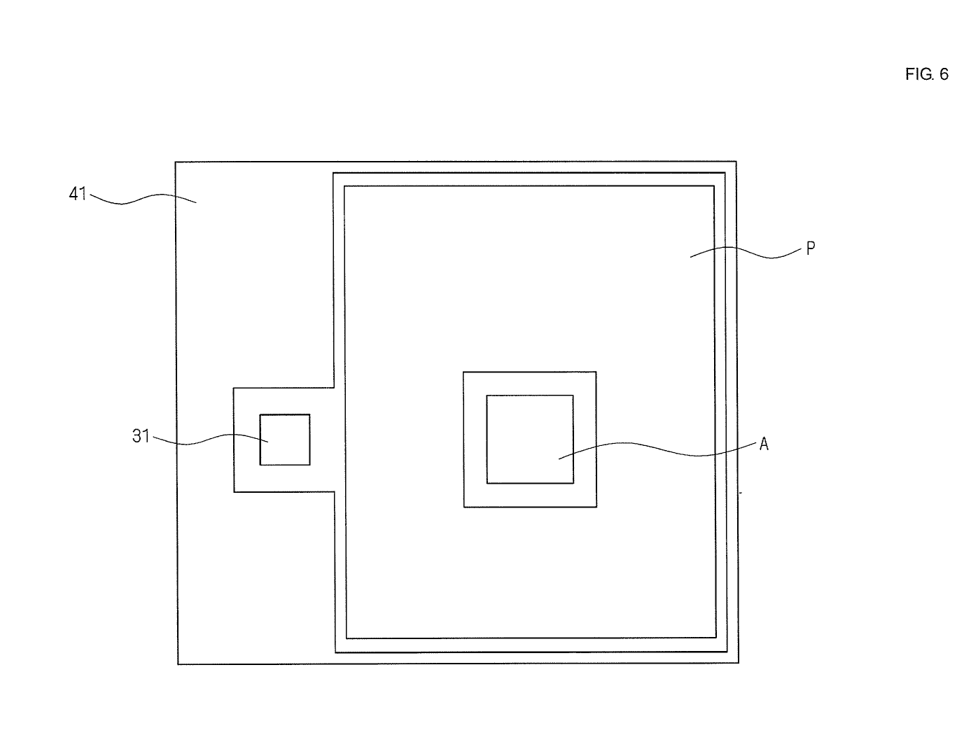

To increase the effectiveness, for example, a configuration in which the first coupling electrode pair A is surrounded by the second coupling electrode pair P may be alternatively adopted. FIG. 5 is a schematic block diagram of another configuration of the power transmission system according to the embodiment 2 of the present invention. FIG. 6 is a schematic plan view of an arrangement of coupling electrode pairs in the power transmission system according to the embodiment 2 of the present invention.

As illustrated in FIG. 5, in the power transmission system according to the embodiment 2, a first passive electrode 11p of a power transmitter device 1 and a second passive electrode 21p of a power receiver device 2 are arranged so as to surround a power transmitter module unit and a power receiver module unit for power transmission. The power transmitter device 1 includes at least a voltage generator circuit 12, a power transmitter module unit including a step-up transformer that is not illustrated, a first active electrode 11a that forms a first coupling electrode pair A, and the first passive electrode 11p that forms a second coupling electrode pair P. Further, the power receiver device 2 includes at least a power receiver module unit including a step-down transformer that is not illustrated and a load circuit 24, a second active electrode 21a that forms the first coupling electrode pair A, and the second passive electrode 21p that forms the second coupling electrode pair P.

Further, in addition to the first coupling electrode pair A and the second coupling electrode pair P for use in power transmission, a communication coupling electrode pair 31 for use in data communication is provided. The power transmission system according to the embodiment 2 allows a casing 10 of the power transmitter device 1 and a casing 20 of the power receiver device 2 to function as a first reference potential electrode 16 and a second reference potential electrode 26 that are each connected to a reference potential.

In other words, the casing 10 of the power transmitter device 1 and the casing 20 of the power receiver device 2 function as a reference potential coupling electrode pair 41 that is connected to the reference potential, and the first communication unit 13 of the power transmitter device 1 is connected to a first communication coupling electrode 31b at one end portion and the casing 10 of the power transmitter device 1 at the other end portion. Further, a second communication unit 23 of the power receiver device 2 is connected to a second communication coupling electrode 31a, which forms capacitive coupling with the first communication coupling electrode 31b, at one end portion and the casing 20 of the power receiver device 2 at the other end portion.

As is clear from FIG. 6, the first coupling electrode pair A that is at a relatively high potential is surrounded by the second coupling electrode pair P that is at a relatively low potential. This arrangement makes an electric field generated by the first coupling electrode pair A difficult to leak beyond the second coupling electrode pair P. Thus, the influence of potential variation superposed on the first communication unit 13 and the second communication unit 23 during power transmission may be reduced, and the SN ratio (signal to noise ratio) of communication signal may be increased. Accordingly, the communication sensitivity may be increased, and the data communication stability may be further improved.

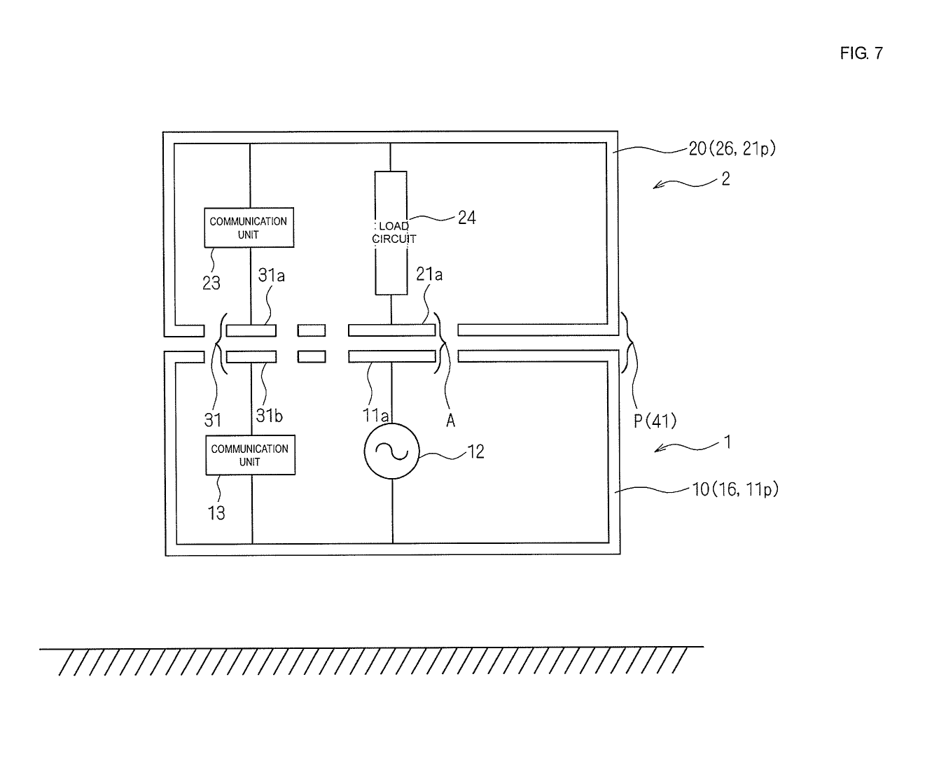

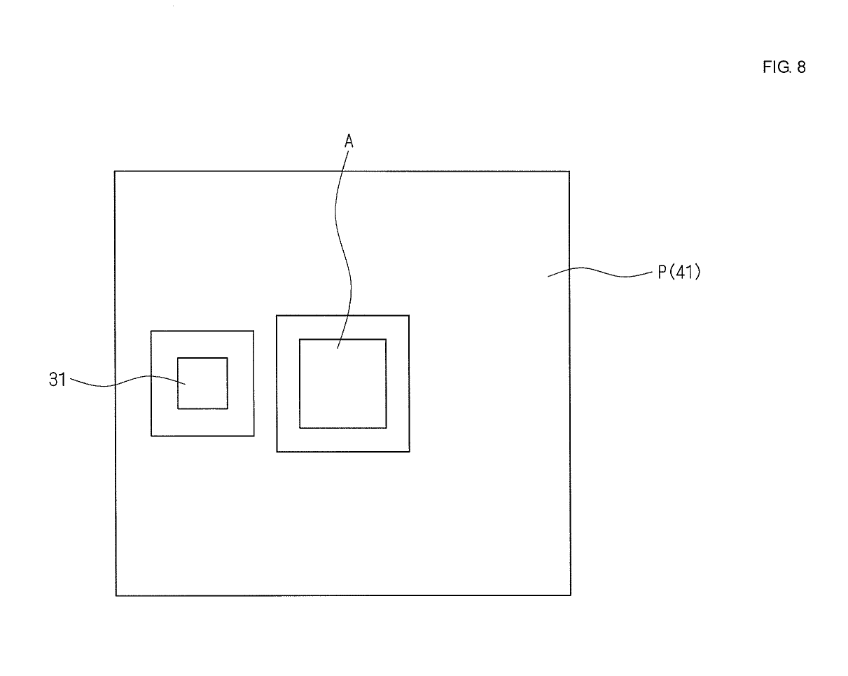

FIG. 7 is a schematic block diagram of another configuration of the power transmission system according to the embodiment 2 of the present invention. FIG. 8 is a schematic plan view of another arrangement of coupling electrode pairs in the power transmission system according to the embodiment 2 of the present invention.

As illustrated in FIG. 7, the power transmission system according to the embodiment 2 is configured so that a first passive electrode 11p of the power transmitter device 1 forms the casing 10 of the power transmitter device 1 and a second passive electrode 21p of the power receiver device 2 forms the casing 20 of the power receiver device 2. The power transmitter device 1 includes at least a voltage generator circuit 12, a power transmitter module unit including a step-up transformer that is not illustrated, and a first active electrode 11a that forms the first coupling electrode pair A. Further, the power receiver device 2 includes at least a power receiver module unit including a step-down transformer that is not illustrated and a load circuit 24, and a second active electrode 21a that forms the first coupling electrode pair A.

Further, in addition to the first coupling electrode pair A for use in power transmission, a communication coupling electrode pair 31 for use in data communication is provided. In the power transmitter device 1, the casing 10 that functions as a first reference potential electrode 16 also functions as the first passive electrode 11p. In the power receiver device 2, the casing 20 that functions as a second reference potential electrode 26 also functions as the second passive electrode 21p. In other words, a second coupling electrode pair P formed of the first passive electrode 11p and the second passive electrode 21p functions as a reference potential coupling electrode pair 41. In FIG. 7, the casing 10 functioning as the first passive electrode 11p floats from a ground potential. Alternatively, the casing 10 may be connected to the ground potential.

A first communication unit 13 of the power transmitter device 1 is connected to a first communication coupling electrode 31b at one end portion and the casing 10 of the power transmitter device 1 at the other end portion. Further, a second communication unit 23 of the power receiver device 2 is connected to a second communication coupling electrode 31a, which forms capacitive coupling with the first communication coupling electrode 31b, at one end portion and the casing 20 of the power receiver device 2 at the other end portion.

As is clear from FIG. 8, the first coupling electrode pair A that is at a relatively high potential is surrounded by the second coupling electrode pair P that functions as the reference potential coupling electrode pair 41. This arrangement prevents an electric field generated by the first coupling electrode pair A from leaking to the surrounding. Thus, the influence of potential variation superposed on the first communication unit 13 and the second communication unit 23 during power transmission may be reduced, and the SN ratio (signal to noise ratio) of communication signal may be increased. Accordingly, the communication sensitivity may be increased, and the data communication stability may be further improved.

As described above, according to the embodiment 2, the reference potential coupling electrode pair 41 (the second coupling electrode pair P may also double as the reference potential coupling electrode pair 41) connected to the reference potential is arranged between the communication coupling electrode pair 31 and the first coupling electrode pair A. This enables to make the communication coupling electrode pair 31 less susceptible to the influence of a relatively high voltage applied to the first coupling electrode pair A during power transmission, suppress potential variations at the first communication unit 13, and increase the SN ratio (signal to noise ratio) of communication signal. Thus, the communication sensitivity may be increased, and the data communication stability may be further improved.

### Embodiment 3

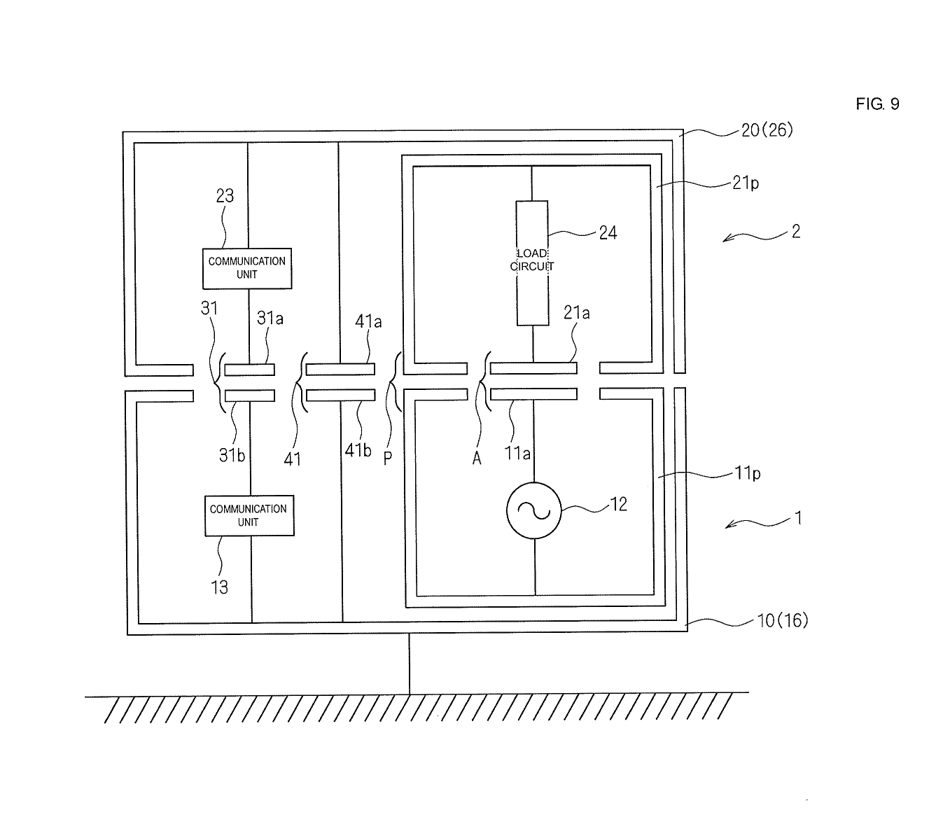

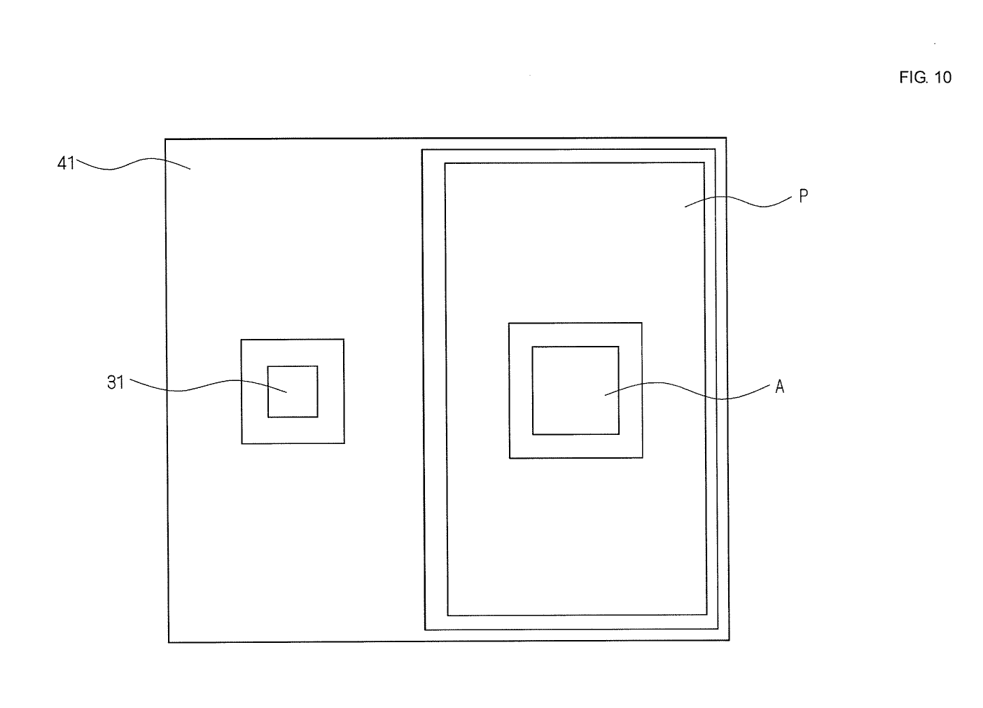

FIG. 9 is a schematic block diagram of a configuration of a power transmission system according to embodiment 3 of the present invention. FIG. 10 is a schematic plan view of an arrangement of coupling electrode pairs in the power transmission system according to the embodiment 3 of the present invention. As illustrated in FIG. 9, in the power transmission system according to the embodiment 3, a first passive electrode 11p of a power transmitter device 1 and a second passive electrode 21p of a power receiver device 2 are formed so as to surround a power transmitter module unit and a power receiver module unit for power transmission, and a reference potential coupling electrode pair 41 is arranged between a communication coupling electrode pair 31 and the module units, the power transmitter module unit and the power receiver module unit for power transmission.

Further, in addition to a first coupling electrode pair A and a second coupling electrode pair P for use in power transmission, the communication coupling electrode pair 31 for use in data communication is provided. The power transmission system according to the embodiment 3 allows a casing 10 of the power transmitter device 1 and a casing 20 of the power receiver device 2 to function as a first reference potential electrode 16 and a second reference potential electrode 26 each connected to a reference potential.

Further, the reference potential coupling electrode pair 41 connected to the reference potential is arranged so as to be arranged between the communication coupling electrode pair 31 for use in data communication and the electrode pairs for use in power transmission, the first coupling electrode pair A and the second coupling electrode pair P. In the reference potential coupling electrode pair 41, a first reference potential electrode 41b at the power transmitter device 1 side is connected to the first reference potential electrode 16 of the power transmitter device 1, namely, the casing 10 of the power transmitter device 1, and a second reference potential electrode 41a at the power receiver device 2 side is connected to the second reference potential electrode 26, namely, the casing 20 of the power receiver device 2.

A first communication unit 13 of the power transmitter device 1 is connected to a first communication coupling electrode 31b at one end portion and the casing 10 of the power transmitter device 1 at the other end portion. Further, a second communication unit 23 of the power receiver device 2 is connected to the second communication coupling electrode 31a, which forms capacitive coupling with the first communication coupling electrode 31b, at one end portion and the casing 20 of the power receiver device 2 at the other end portion.

As is clear from FIG. 10, the first coupling electrode pair A that is at a relatively high potential is surrounded by the second coupling electrode pair P that is at a relatively low potential. This arrangement makes an electric field generated by the first coupling electrode pair A difficult to leak beyond the second coupling electrode pair P. Further, the reference potential coupling electrode pair 41 is arranged between the communication coupling electrode pair 31 and the electrode pairs, the first coupling electrode pair A and the second coupling electrode pair P. Thus, the influence of potential variation superposed on the first communication unit 13 and the second communication unit 23 during power transmission may be reduced, and the SN ratio (signal to noise ratio) of communication signal may be increased. Accordingly, the communication sensitivity may be increased, and the data communication stability may be further improved.

As described above, according to the embodiment 3, the reference potential coupling electrode pair 41 connected to the reference potential is arranged between the communication coupling electrode pair 31 and the electrode pairs, the first coupling electrode pair A and the second coupling electrode pair P. Further, according to the embodiment 3, the first coupling electrode pair A and the second coupling electrode pair P are arranged so that the first coupling electrode pair A that is at a relatively high potential is surrounded by the second coupling electrode pair P that is at a relatively low potential. This enables to make the communication coupling electrode pair 31 less susceptible to the influence of a relatively high voltage applied to the first coupling electrode pair A during power transmission and suppress potential variations at the first communication unit 13, making it possible to increase the SN ratio (signal to noise ratio) of communication signal. Thus, the communication sensitivity may be increased, and the data communication stability may be further improved.

### Embodiment 4

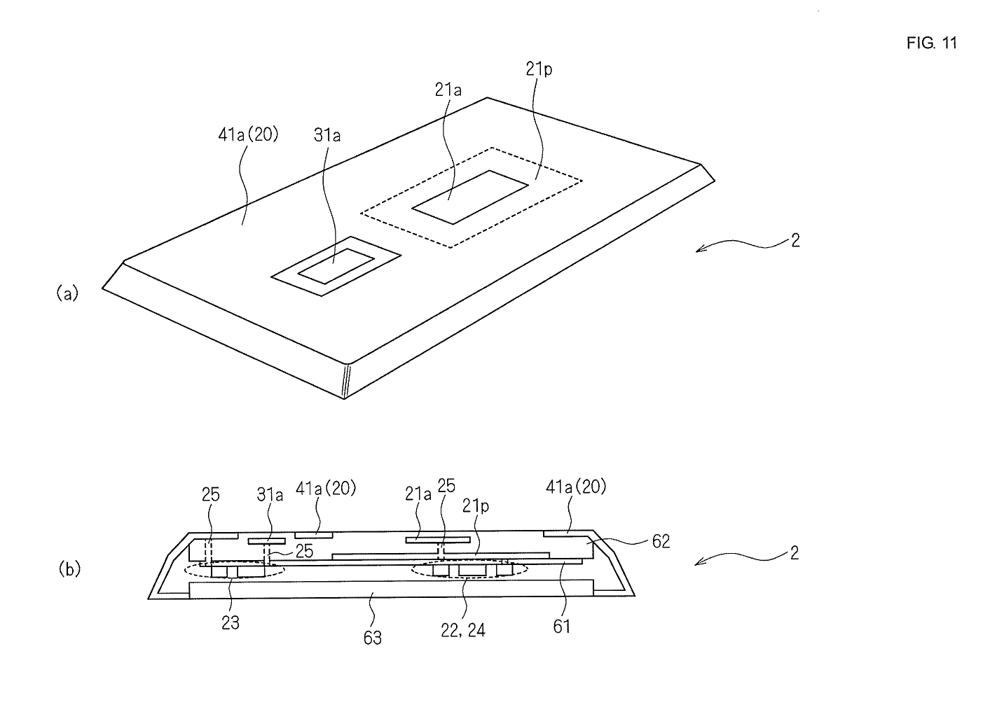

FIG. 11 is a schematic diagram of a smartphone that forms a power receiver device 2 of a power transmission system according to embodiment 4 of the present invention. FIG. 11(a) is a schematic perspective view illustrating a back side configuration of the power receiver device 2 according to the embodiment 4 of the present invention. FIG. 11(b) is a schematic longitudinal cross sectional diagram illustrating a configuration of the power receiver device 2 according to the embodiment 4 of the present invention.

As illustrated in FIG. 11(a), the power receiver device 2 of the power transmission system according to the embodiment 4 includes a second active electrode 21a at its back side. A second passive electrode 21p is arranged at a position inside the power receiver device 2 behind the second active electrode 21a and has a profile illustrated with a dashed line in the drawing. The power receiver device 2 further includes an second communication coupling electrode 31a at a position separated from the second active electrode 21a. A second reference potential electrode 41a formed of a casing 20 is arranged at the periphery of the second passive electrode 21p and the second communication coupling electrode 31a. The second reference potential electrode 41a forms a reference potential coupling electrode pair 41.

As illustrated in FIG. 11(b), a rectifier circuit 22 and a load circuit 24 are arranged on a printed board 61 inside the smartphone. A display portion 63 is disposed on one side, and an insulator 62 is disposed on the other side (back side of the power receiver device 2). The casing 20 that is a conductor is disposed on the surface of the insulator 62 as the second reference potential electrode 41a (reference potential coupling electrode pair 41). Further, a second communication unit 23 is connected to the second reference potential electrode 41a (casing 20) and the second communication coupling electrode 31a through via-electrodes 25, and the second active electrode 21a is connected to the second passive electrode 21p through a via-electrode 25.

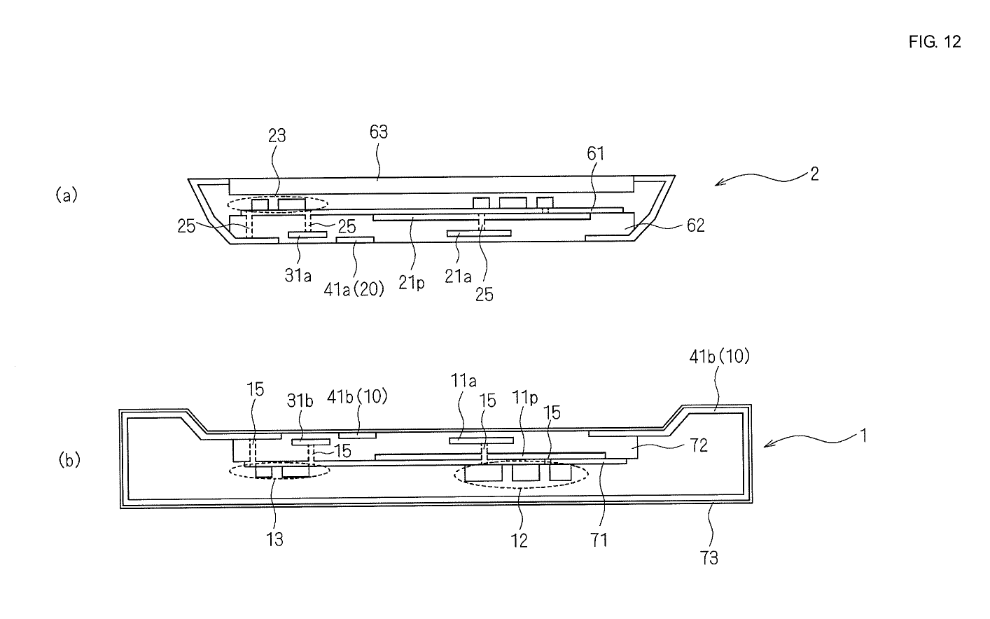

FIG. 12 is a schematic longitudinal cross sectional diagram illustrating configurations of a power transmitter device 1 and the power receiver device 2 of the power transmission system according to the embodiment 4 of the present invention. FIG. 12(a) is a schematic longitudinal cross sectional diagram illustrating the configuration of the power receiver device 2 of the power transmission system according to the embodiment 4 of the present invention. FIG. 12(b) is a schematic longitudinal cross sectional diagram illustrating the configuration of the power transmitter device 1 of the power transmission system according to the embodiment 4 of the present invention. As illustrated in FIG. 12(b), the power transmitter device 1 of the power transmission system according to the embodiment 4 is configured so that first coupling electrodes formed of the first active electrode 11a and the first passive electrode 11p are arranged at a surface side on which the power receiver device 2 is placed. In other words, the power transmitter device 1 includes a first active electrode 11a at the surface side on which the power receiver device 2 is placed. The first active electrode 11a is disposed at a position that corresponds to the coupling electrodes of the power receiver device 2. A first passive electrode 11p is arranged at a position inside the power transmitter device 1 behind the first active electrode 11a. The power transmitter device 1 further includes an first communication coupling electrode 31b at a position separated from the first passive electrode 11p. A first reference potential electrode 41b formed of a casing 10 is arranged at the periphery of the first active electrode 11a and the first communication coupling electrode 31b that are provided at the surface side on which the power receiver device 2 is placed. The whole of the power transmitter device 1 including the first active electrode 11a, the first communication coupling electrode 31b, and the first reference potential electrode 41b (casing 10) of the power transmitter device 1 is insulated by being covered with an insulator 73. Although it is not illustrated, similarly, the second active electrode 21a, the second communication coupling electrode 31a, and the second reference potential electrode 41a (casing 20) of the power receiver device 2 may also be insulated by being covered with an insulator.

A first communication unit 13 and a voltage generator circuit 12 are arranged on a printed board 71 inside the power transmitter device 1. An insulator 72 is disposed at the surface side on which the power receiver device 2 is placed, and the casing 10 that is a conductor is disposed on its surface as the first reference potential electrode 41b. The first passive electrode 11p having a larger electrode area than that of the first active electrode 11a is arranged at the printed board 71 side whereas the first active electrode 11a having a smaller electrode area is arranged at the surface side on which the power receiver device 2 is placed. The first active electrode 11a is connected to a first end portion of the voltage generator circuit 12 through a via-electrode 15 that penetrates through the insulator 72, the first passive electrode 11p, and the printed board 71. The first passive electrode 11p is connected to a second end portion of the voltage generator circuit 12 through a via-electrode 15 that penetrates through the printed board 71.

As is the case with the embodiment 3, in the embodiment 4, a first coupling electrode pair A for use in power transmission is formed of the first active electrode 11a of the power transmitter device 1 and the second active electrode 21a of the power receiver device 2. Similarly, a second coupling electrode pair P is formed of the first passive electrode 11p of the power transmitter device 1 and the second passive electrode 21p of the power receiver device 2. A communication coupling electrode pair 31 is formed of the first communication coupling electrode 31b of the power transmitter device 1 and the second communication coupling electrode 31a of the power receiver device 2. The reference potential coupling electrode pair 41 is formed of the first reference potential electrode 41b at the power transmitter device 1 side and the second reference potential electrode 41a at the power receiver device 2 side.

A first communication unit 13 of the power transmitter device 1 is connected to the first communication coupling electrode 31b and the first reference potential electrode 41b (casing 10). A second communication unit 23 of the power receiver device 2 is connected to the second communication coupling electrode 31a and the second reference potential electrode 41a (casing 20). Accordingly, a reference potential of the first communication unit 13 becomes stable.

Further, the reference potential coupling electrode pair 41 is arranged between the first coupling electrode pair A for use in power transmission and the communication coupling electrode pair 31 for use in data communication. Accordingly, the first communication unit 13 is less susceptible to the influence of potential variation even when power transmission is performed at high voltage, making it possible to perform stable data communication and the power transmission at the same time.

Further, needless to say, the present invention is not limited to the foregoing examples, and various modifications, replacements, and the like may be made within the scope of the present invention. For example, in the foregoing embodiments, the first reference potential electrode 16 is arranged at the casing 10 or formed as the casing 10. Alternatively, the first reference potential electrode 16 may be a ground potential electrode provided in a power transmitter circuit board. Further, in the foregoing embodiments, the second reference potential electrode 26 is arranged at the casing 20 or formed as the casing 20. Alternatively, the second reference potential electrode 26 may be a ground potential electrode provided in a power receiver circuit board.

### REFERENCE SIGNS LIST

1 Power transmitter device
2 Power receiver device
10, 20 Casing
11a First active electrode (first coupling electrode)
11p First passive electrode (first coupling electrode)
12 Voltage generator circuit
13 First communication unit
16 First reference potential electrode
21a Second active electrode (second coupling electrode)
21p Second passive electrode (second coupling electrode)
22 Rectifier circuit
23 Second communication unit
24 Load circuit
26 Second reference potential electrode
31 Communication coupling electrode pair
31a Second communication coupling electrode
31b First communication coupling electrode
41 Reference potential coupling electrode pair
A First coupling electrode pair
B, P Second coupling electrode pair

1. A power transmission system comprising:
a power transmitter device including:
a pair of first coupling electrodes,
a first reference potential electrode,
a first communication coupling electrode, and
a first data communication unit coupled to the first communication coupling electrode and the first reference potential electrode; and
a power receiver device including:
a pair of second coupling electrodes,
a second reference potential electrode,
a second communication coupling electrode, and
a second data communication unit coupled to the second communication coupling electrode and the second reference potential electrode,
wherein electric power is transmitted by capacitive coupling between the pair of first coupling electrodes and the pair of second coupling electrodes when the power receiver device is positioned adjacently to the power transmitter device, and
wherein the first communication coupling electrode forms capacitive coupling with the second communication coupling electrode when the power receiver device is positioned adjacently to the power transmitter device.

2. The power transmission system according to claim 1,
wherein the first communication unit includes a first end portion coupled to the first communication coupling electrode and a second end portion coupled to the first reference potential electrode, and
wherein the second communication unit includes a first end portion coupled to the second communication coupling electrode and a second end portion coupled to the second reference potential electrode.

3. The power transmission system according to claim 1, wherein the first reference potential electrode is coupled between the first communication coupling electrode and the pair of first coupling electrodes, and the second reference potential electrode is coupled between the second communication coupling electrode and the pair of second coupling electrodes.

4. The power transmission system according to claim 1, wherein the first reference potential electrode of the power transmitter device is connected to a ground potential of the power transmitter.

5. The power transmission system according to claim 1,
wherein one of the pair of first coupling electrodes of the power transmitter device surrounds a voltage generator circuit of the power transmitter device, and
wherein one of the pair of second coupling electrodes of the power receiver device surrounds a load circuit of the power receiver device.

6. A power transmission system comprising:
a power transmitter device having:
first coupling electrodes including a first passive electrode and a first active electrode with a higher potential than the first passive electrode,
a first communication coupling electrode, and
a first communication unit coupled to first communication coupling electrode and to a reference potential of the power transmitter device; and
a power receiver device having:
second coupling electrodes including a second passive electrode and a second active electrode with a higher potential than the second passive electrode,
a second communication coupling electrode, and
a second communication unit coupled to a second communication coupling electrode and to a reference potential of the power receiver device,
wherein electric power is transmitted by capacitive coupling between the first coupling electrodes and the second coupling electrodes when the power receiver device is positioned adjacently to the power transmitter device, and
wherein the first communication coupling electrode forms capacitive coupling with the second communication coupling electrode when the power receiver device is positioned adjacently to the power transmitter device,

7. The power transmission system according to claim 6,
wherein the first communication unit includes a first end portion coupled to the first communication coupling electrode and a second end portion coupled to the reference potential of the power transmitter device, and
wherein the second communication unit includes a first end portion coupled to the second communication coupling electrode and a second end portion coupled to the reference potential of the power receiver device.

8. The power transmission system according to claim 6, wherein the first passive electrode is coupled between the first active electrode and the first communication coupling electrode, and the second passive electrode is coupled between the second active electrode and the second communication coupling electrode

9. The power transmission system according to claim 6,
wherein the power transmitter device further includes a first reference potential electrode disposed between the first passive electrode and the first communication coupling electrode, and
wherein the power receiver device includes a second reference potential electrode disposed between the second passive electrode and the second communication coupling electrode.

10. The power transmission system according to claim 9, wherein the first reference potential electrode of the power transmitter device is connected to a ground potential.

11. A power transmitter device for transmitting electric power to a power receiver device including a pair of second coupling electrodes, a second communication unit, and a second communication coupling electrode, the power transmitter device comprising at least:
a pair of first coupling electrodes;
a first reference potential electrode;
a first communication coupling electrode; and
a first communication unit that facilitates data communication with the power receiving device and that is coupled to the first reference potential electrode and the first communication coupling electrode.

12. The power transmitter device according to claim 11, wherein the first communication unit includes a first end portion coupled to the first communication coupling electrode and a second end portion coupled to the first reference potential electrode.

13. The power transmitter device according to claim 11, wherein the first reference potential electrode is coupled between the first communication coupling electrode and the first coupling electrode.

14. The power transmitter device according to claim 11, wherein the first reference potential electrode is connected to a ground potential.

15. The power transmitter device according to claim 11, further comprising a voltage generator circuit, wherein one of the pair of first coupling electrodes of the power transmitter device surrounds the voltage generator circuit.

16. A power transmitter device for transmitting electric power to a power receiver device having second coupling electrodes including a second passive electrode and a second active electrode with a higher potential than the second passive electrode, a second communication unit, and a second communication coupling electrode, the power transmitter device comprising:
first coupling electrodes including a first passive electrode and a first active electrode with a higher potential than the first passive electrode;
a first communication coupling electrode; and
a first communication unit coupled to the first communication coupling electrode and to a reference potential of the power transmitter device.

17. The power transmitter device according to claim 16, wherein the first communication unit includes a first end portion coupled to the first communication coupling electrode and a second end portion coupled to the reference potential of the power transmitter device.

18. The power transmitter device according to claim 16, wherein the first passive electrode is coupled between the first active electrode and the first communication coupling electrode.

19. The power transmitter device according to claim 16, further comprising a first reference potential electrode disposed between the first passive electrode and the first communication coupling electrode.

20. The power transmitter device according to claim 19, wherein the first reference potential electrode is connected to a ground potential.
